(19) United States
(12) Patent Application Publication
(10) Pub. No.: US 2009/0177532 A1
(43) Pub. Date: Jul. 9, 2009

(54) SELF SERVE ADVERTISING SYSTEM AND METHOD

(76) Inventors: Spencer Brown, Van Nuys, CA (US); Arnie Gullov-Singh, Los Angeles, CA (US)

Correspondence Address: Cantor Colburn LLP - Fox Entertainment Group, 20 Church Street, 22nd Floor, Hartford, CT, 06103, US

(21) Appl. No.: 12/349,596

(22) Filed: Jan. 7, 2009

Related U.S. Application Data
(60) Provisional application No. 61/010,353, filed on Jan. 7, 2008.

(51) Int. Cl. G06Q 30/00; G06Q 40/00; G06Q 10/00; G06F 3/048; G06F 17/00; G06F 17/30

(52) U.S. Cl. 705/10; 705/14; 705/30; 705/34; 705/40; 715/764; 707/100; 707/10; 715/783; 707/E17.044

(57) ABSTRACT

A self serve advertising platform and method is provided, including an interface that permits users to sign up, create accounts, create, customize or upload advertisements, create campaigns, including defining campaign objectives and parameters, set budgetary and time constraint limits on the advertising, and analyze the performance of one or more such ad campaigns.

### CROSS REFERENCE TO RELATED APPLICATIONS

The present application claims priority to U.S. Provisional Patent Application Ser. No. 61/010,353, filed Jan. 7, 2008, the entire contents of which are specifically incorporated by reference herein.

### BACKGROUND

Advertising online is a driving force for internet web sites. While larger corporations have the ability and the budget to negotiate with advertising sales representatives at any potentially relevant online community (e.g., MySpace), smaller entities (smaller businesses, artists, restaurant owners, etc.) oftentimes do not have the resources to do so or the tools to determine whether contacting a representative at a particular online community would be profitable.

In an exemplary application, it is useful to recognize that the MySpace community is the largest online community and the sixth largest property on the Web. According to comScore Media Metrix, MySpace attracted over 55 million unique visitors, a reach of 32%, in the month of September 2006.

According to the US Census Bureau there are 20 million businesses in the US. In light of the above figures, it may be estimated that of those 20 million, at least 1 million have a MySpace profile. This does not even account for the over 4 million bands, over 50 thousand filmmakers, and over 15 thousand comedians with MySpace profiles.

The marketplace would greatly benefit from an effective system for providing smaller entities tools for advertising.

### SUMMARY

The above-described and other disadvantages of the prior art are overcome and alleviated by the presently described self serve advertising platform and method. The presently described online advertising system advantageously provides users with a mechanism to promote their business and themselves to online communities (e.g., online social networking communities), effectively creating “usertisers.” This system does so by providing an easy interface that permits users to sign up, create accounts, create, customize or upload advertisements, create campaigns, including defining campaign objectives and parameters, set budgetary and time constraint limits on the advertising, and analyze the performance of one or more such ad campaigns.

All of these MySpace users will greatly benefit from a system that allows them to promote their business or themselves to others in their community. Exemplary embodiments of the presently described system permits “usertisers” to easily create their own ads, target a specific audience, and/or control how much they spend.

### BRIEF DESCRIPTION OF THE DRAWINGS

Referring now to the drawings, wherein like elements are numbered alike in the following figure:

FIG. 1 is an exemplary systems diagram illustrating the interface relationship between an ad serving system and an exemplary self serve advertising platform in accordance with the invention;

FIG. 2 is a more detailed exemplary architecture for the present self serve advertising platform;

FIG. 3 is a flowchart illustrating an exemplary signup process;

FIG. 4 is an exemplary promotional page for enticing users to signup;

FIG. 5 is an exemplary promotional page for enticing users to signup;

FIG. 6 is an exemplary promotional page for enticing users to signup;

FIG. 7 is an exemplary promotional page for enticing users to signup;

FIG. 8 is an exemplary advertisement build or upload interface;

FIG. 9 is an exemplary workflow chart for ad building;

FIG. 10 is an exemplary template for ad building;

FIG. 11 is an exemplary workspace, including a blank template for ad building;

FIG. 12 is an exemplary image browser for ad building;

FIG. 13 is an exemplary workspace with an image toolbar selected for ad building;

FIG. 14 is an exemplary workspace with a text toolbar selected for ad building;

FIG. 15 is an exemplary ad targeting screen;

FIG. 16 is an exemplary campaign budget screen;

FIG. 17 is an exemplary order review and billing screen;

FIG. 18 is an exemplary confirmation screen;

FIG. 19 is an exemplary workflow for an advertisement management center;

FIG. 20 is an exemplary user homepage management center widget;

FIG. 21 is an exemplary management center homepage;

FIG. 22 is an exemplary campaign summary for a campaign manager;

FIG. 23 is an exemplary chart of available actions according to campaign state;

FIG. 24 is an exemplary campaign details page;

FIG. 25 is an exemplary workflow for incorporation of a previously approved ad into a campaign;

FIG. 26 is an exemplary workflow for upload of an ad into a campaign;

FIG. 27 is an exemplary workflow for building an ad into a campaign;

FIG. 28 is an exemplary campaign report screen;

FIG. 29 is an exemplary user billing information screen;

FIG. 30 is an exemplary password verification screen;

FIG. 31 is an exemplary billing edit screen;

FIG. 32 is an exemplary user preferences screen;

FIG. 33 is an exemplary help/FAQ screen;

FIG. 34 is an exemplary help/questions submission screen;

FIG. 35 is an exemplary workflow for administrator review and approval;

FIG. 36 is an exemplary workflow for administrator ad review;

FIG. 37 is an exemplary administrator ad review screen;

FIG. 38 is an exemplary administrator user search screen;

FIG. 39 is an exemplary administrator campaign summary screen;

FIG. 40 is an exemplary administrator campaign details screen;

FIG. 41 is an exemplary administrator billing screen;

FIG. 42 is an exemplary administrator audit trail screen;

FIG. 43 is an exemplary administrator reports screen;

FIG. 44 is an exemplary administrator image review screen;

FIG. 45 is an exemplary administrator image review screen;

FIG. 46 is an exemplary administrator home page screen;

FIG. 47 is an exemplary administrator image review screen;

FIG. 48 is an exemplary administrator image review screen; and

FIG. 49 is an exemplary administrator user profile review screen.

### DETAILED DESCRIPTION

Reference will now be made in detail to exemplary embodiments, examples of which are illustrated by the accompanying drawing. As indicated above, the presently described online advertising systems enables registered website users to buy display advertising on the website.

In an exemplary embodiment, the system platform includes three main subsystems: a signup process, a management center, and an administrative center.

In exemplary embodiments, the platform includes one or more of the following core features for creating and managing ad campaigns:
The ability to build display ads;
The ability to target users, e.g., demographically and geographically;
The ability to set a budget and start and end dates;
The ability to collect billing information and charge based on a regular billing cycle;
The ability to provide internal and external reports; and
The ability to provide internal administrative access to usertiser campaigns.

The following description will, for the sake of providing a convenient example, describe provision of an online advertising system platform for musical bands on the MySpace social network. However, it should be recognized that the present disclosure encompasses provision of platform advertising resources not just to bands, but more generally to any interested business, group or individual. Also, the present self serve platform is applicable not just to MySpace, and not just to social networks, but to any network. Thus, it should be recognized that any reference to MySpace, social networks, or particular user categories are exemplary only, and is not intended to limit the scope of the invention described herein.

### Self Service Platform Overview

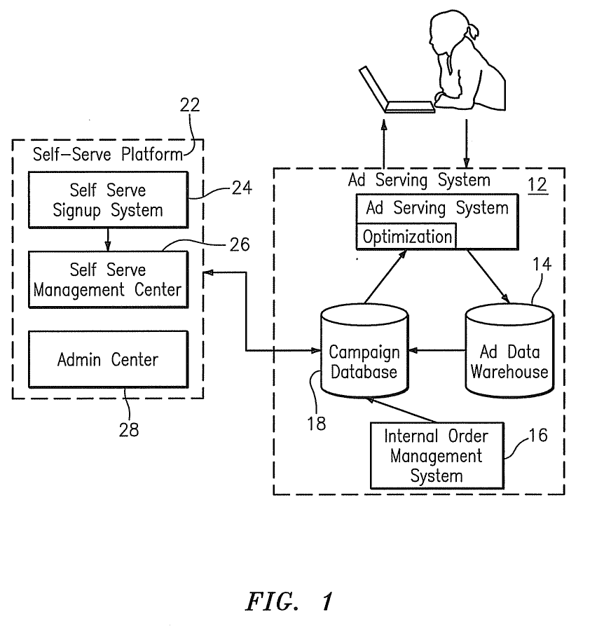

Reference is made to FIG. 1, which displays the interaction and responsibilities of the various exemplary components described within this document. An advertisement serving system 12 includes an ad data warehouse 14, an internal order management system 16 and a campaign database 18. The ad serving system 12 may also include ad server optimization components 20.

Exemplary ad delivery steps via the ad serving system follows:
Page view generates an ad request to the ad server
Ad server parses the request to extract the following:
   User cookie
   Page requesting the ad
   Location requesting the ad
Ad server calls GeoIP lookup service with the user IP to determine location of user (if not available from User cookie)
Ad server determines what ads are available given the user, the ad's budget, and the ad's targeting constraints
Ad server returns the highest yielding ad available
Ad server logs the following events for the ad request:
   Timestamp
   Page/location requesting ad
   User info
   Ad served
   Click (y/n)

In order to permit self service for the ad serving system 12, a self serve platform 22 provides an interface between the user (e.g., a band or small business) and the ad serving system 12 without requiring in-person or over the phone interaction between the user and an ad serving agent (who would otherwise set up and run the account and advertising campaign tailored to the user). The exemplary illustrated self serve platform includes a self serve signup system 24, a self serve management center 26 and an admin center 28.

In exemplary embodiments, the self-serve platform includes customized user interfaces to facilitate the signup, the management, and the administration of self service usertisers. In exemplary embodiments, the system may require that the Usertisers have a relevant working network profile (e.g., for MySpace self-serve, a working Myspace profile). In other exemplary embodiments, the system may have access to user profile information (registration information) and content (pictures). From the above, or otherwise (e.g., utilizing a self-contained database for the self serve platform or permitting uploading of content for use), the Usertiser will have the ability to create and manage at least one (and in exemplary embodiments, multiple) active campaigns.

Where contact is desired with the user, communications to the user may be sent an email address specified by the user (this may or may not be the email address specified in the user's network profile).

As is noted above, the present system permits a user to create an ad campaign tailored by the user (note that the term user and “usertiser” are used synonymously herein). In exemplary embodiments, the system may require that each created campaign have a unique name (with no HTML in the name) and only one active ad (although ads may be shared across campaigns).

The system may also be configured to allow the user (and/or recommend to the user) targeting criteria for a campaign, budgeting and timing for the campaign, and start and end dates for the campaign (the system may lock dates into a particular time zone, e.g. PST). In exemplary embodiments, campaigns may be assigned status identifiers (e.g., as follows):
Active—Campaign with approved Ad that is currently running
Pending Approval—Campaign with pending Ad approval from MySpace Customer Admin
User Paused —Active or Pending Approval Campaign that has been paused by the user
System Paused—Active and/or Pending Campaign paused by system due to insufficient funds or expired credit card
Admin Paused—Campaign paused by a MySpace Admin from the Admin tool
In-Complete—Campaign with Ad that has been rejected by MySpace Customer Admin; Campaign that has not been submitted for approval to MySpace Customer Admin; Campaign that does not have all required fields complete
New—Campaign that has never been saved
Complete—Completed Active Campaign that finished by calendar end date or by budget allocation being met

In exemplary embodiments, the presently described self serve advertising system permits users to build their own ad (or upload an ad) via an “Ad Builder” user interface (or ad upload interface). In exemplary embodiments, the system requires that ads created with the Ad Builder may only be created in association with a campaign. Also, the ads may be constructed to point to the user's network profile. Ads may also be assigned one of the following exemplary state codes:
Non-Submitted—Ad has not been submitted for approval to MySpace Customer Admin
Approved—Ad has been approved by MySpace Admin
Pending—Ad is awaiting approval from MySpace Admin
Rejected—Ad has been rejected by MySpace Admin and removed

In accordance with the above, the system may be configured to require human review of new ads before they may be implemented. Such review may be required for:
Active Usertisers—a usertiser that has completed the sign-up process
New or Modified ads for active campaigns
Paused campaigns that require ad approval to become active

The system may also be configured to require re-review of modified ads. An “Ad Library” may be provided to the user to give access to approved ads and/or ads pending approval.

As is mentioned above, creation and modification of ads may be done through an “Ad Builder” interface. Such system may allow the user to assign a unique name to the ad (at least unique with regard to the user's ads and campaigns). When saving the ad, should a new name be supplied, then the system may provide that the original (or older) ad version be preserved. The Ad Builder may also have access to the user's network profile, including any media (pictures, etc) associated with that profile and/or permit upload of media from a user terminal. The system may also be configured to allow export of the ad from the Ad Builder to a designated location for review or storage, including layered versions and/or a complete flat image of the ad and all the required components needed to rebuild the ad with an XML describing the position of all the components.

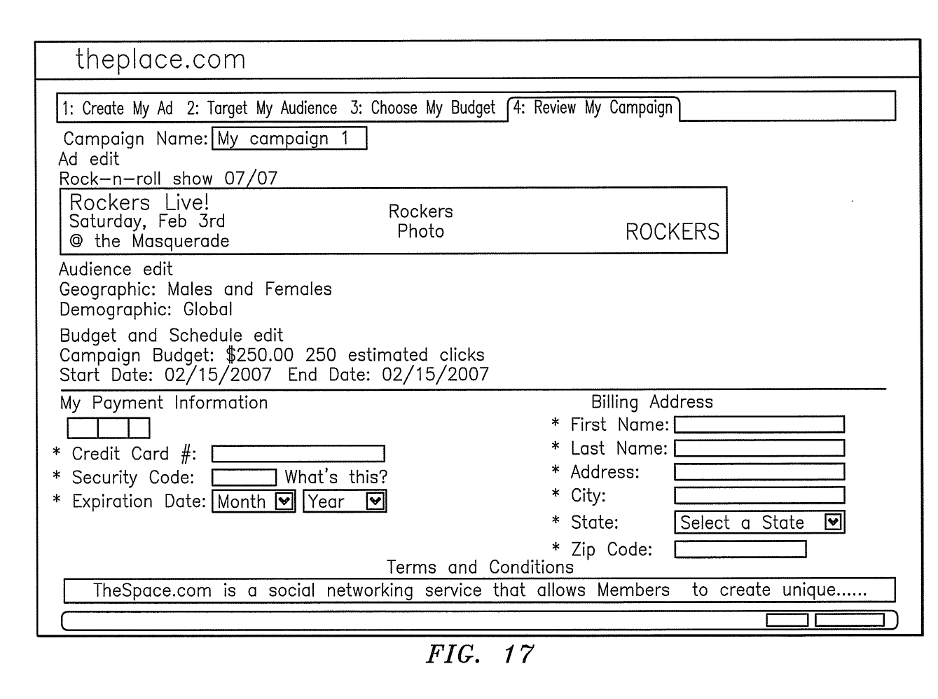

With regard to targeting parameters, the system may be configured to target any category, e.g., group, bias, preference, locale. Reference is made to FIG. 15, which illustrates an exemplary targeting screen. In one exemplary embodiment, the system allows the user to configure the following demographic targeting options:
Males/females
All ages/age range (minimum age is 14, maximum age set to 65+)

In another exemplary embodiment, the system allows the user to configure geographic targeting options (The geography information of the user may be determined from their IP address, e.g., via Quova's GeoTP services). Reference is again made to FIG. 15, which illustrates an exemplary targeting screen. Exemplary geographic options include (a map may also be provided):
Global
National
Regional
City, State
Zip Code (with a mileage radius)

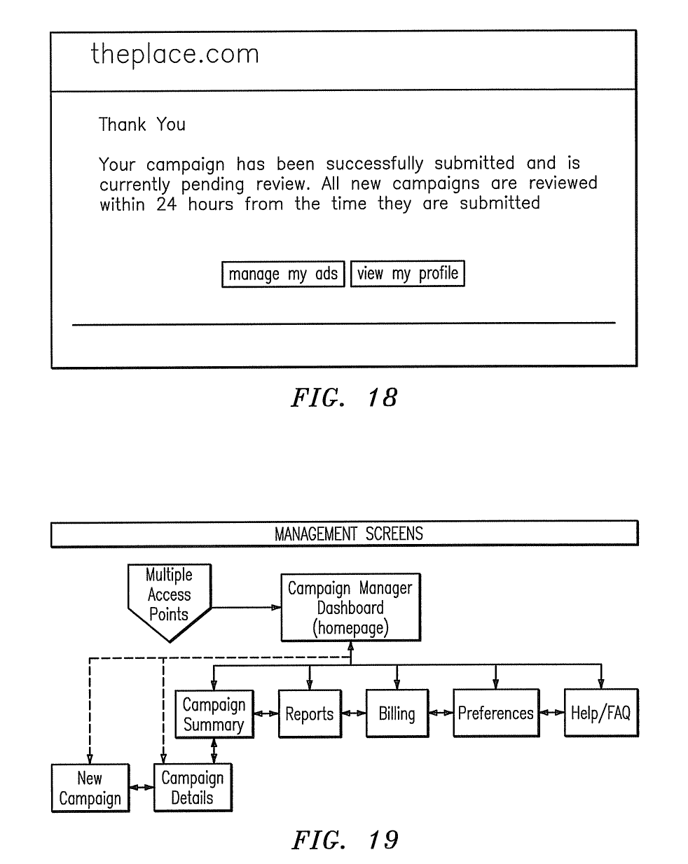

In exemplary embodiments, the system may also allow the user to set budget and timing (The user may enter start and end dates for the campaign) parameters for one or more ad campaigns. FIG. 16 illustrates an exemplary budget and timing interface screen. The user may input a monetary limit (e.g, $25 US Dollars) for a particular campaign. Further, the system may be configured to calculate an estimated number of profile views based on that limit (e.g., $25 may translate to 250 profile views if the campaign is priced at 10 cents per click). The system may also be configured to spend a user's budget evenly through the campaign. In the case of a cost per click (CPC) pricing model, users are charged when their ads receive a click. The user may or may not know the cost per click (but instead may just see an estimation as above based on their budget).

Various billing models may be utilized. For example, the system may bill the user every 30 days, or when the user reaches their credit limit. The 30 days may start when the first campaign becomes active. Also, an initial standard credit limit may be set at a conservative level (e.g., $50), which level may be adjusted based on user credit. Also, the credit limit may be set to raise incrementally each time the user hits their credit limit prior to the end of the 30 days period, e.g.:
$50.00->$100.00
$100.00->$250.00
$250.00->$500.00
$500.00->$1000.00

An example of a timeline for the above follows:
User's initial campaign activates;
10 days later, the user reaches the initial credit limit of $50;
The user is charged for the amount accrued (which may be slightly above $50), and a receipt/post alert is sent;
The user's credit limit is increased to $100;
A new billing cycle begins;
15 days later, the credit limit of $100 is reached;
The user is charged for costs accrued, and a receipt/post alert is sent;
The user's credit limit is increased to $250;
A new billing cycle begins;
30 days pass without reaching the $250 credit limit;
The user is charged for the costs accrued, and a receipt/post alert is sent;
A new billing cycle begins.

The system may be configured to accept credit cards (See FIG. 17 for an exemplary billing screen), which in the case of an account billed periodically (i.e., no up front payment), should generally be stored in the user's account for periodic billing. A campaign may be suspended if such card is considered or becomes to be considered invalid or unusable.

The system may also be configured such that certain situations trigger a user alert. For example, an alert may be triggered for:

Last day of a campaign (for campaign of 3 or more days)
Completion of a campaign
Campaign paused
Administrative campaign stop
Credit card payment made
Credit card payment declined
Credit card about to expire
Credit card expired
Campaign's ad has been approved
Campaign's ad has been rejected
Campaign's ad is pending approval
New user signup

Such alerts may be posted in an “alerts section” of the Management Center 26 and/or be sent as an email to the user. The user may be given the option to opt out of certain alerts (e.g., last day of campaign, etc.). With reference to TABLE 1 below, the following are more exemplary alerts:

| Alert Type | Description |
|---|---|
| Last Day of Campaign | <Campaign Name> is ending today <end date>. |
| | This alert can be managed in preferences |
| | This alert will disappear if user updates campaign end date |
| | This alert will disappear once campaign end date has expired |
| | This alert will disappear once user selects remove |
| Completion of Campaign | <Campaign Name> has ended. View campaign performance. |
| | Campaign Performance takes user to that campaigns filtered report |
| | This alert can be managed in preferences |
| | This alert will disappear once user selects remove |
| Campaign Paused | <Campaign Name> has been paused for <xx> amount of days |
| | This alert can be managed in preferences, with specific number of days |
| | selected (see preferences use case) |
| | This alert will disappear once user selects remove |
| Administrative Campaign | We have stopped <Campaign Name>. For more information, please contact |
| Stop | <contact info> |
| | This alert will disappear once user selects remove |
| Credit Card Payment Made | Your credit card ending with <1234> has been charged in the amount of |
| | $<xx.xx> on <month, day and year> |
| | The amount charged will appear |
| | the credit card charged last four digits will appear |
| | the day, month and year the charge was processed will appear |
| | This alert will disappear once user selects remove |
| Credit Card Declined | Your credit card ending with <1234> has been declined. Please contact your |
| | credit card company or update your billing information. |
| | update your billing information takes user to Billing page |
| | the credit card charged last four digits will appear |
| | This alert will disappear once user updates billing info with approved credit card |
| | This alert will disappear once user selects remove |
| Credit Card about to expire | Your credit card ending with <1234> is about to expire in <xx> days. Please |
| | update your billing information. |
| | the credit card charged last four digits will appear |
| | update your billing information takes user to Billing page |
| | the number of days before expiration will appear |
| | the alert will disappear once user updates billing info with approved credit card |
| | This alert will disappear once user selects remove |
| Credit Card Expired | Your credit card ending with <1234> has expired. Please |
| | update your billing information. |
| | update your billing information takes user to Billing page |
| | the credit card charged last four digits will appear |
| | This alert will disappear once user updates billing info with approved credit card |
| | This alert will disappear once user selects remove |
| Campaign's ad has been | <Ad Name> advertisement in <Campaign Name> has been approved |
| approved | the Ad name and campaign name will take user to selected campaign details |
| | This alert will disappear once user selects remove |
| Campaign's ad has been | <Ad Name> advertisement in <Campaign Name> has been rejected. |
| rejected | the Ad name and campaign name will take user to selected campaign details |
| | This alert will disappear once user selects remove |
| Campaign's ad is pending | <Ad Name> advertisement in <Campaign Name> is pending approval |
| approval | the Ad name and campaign name will take user to selected campaign details |
| New user signup | This alert will disappear once ad has been approved |
| | This alert will disappear once user selects remove |
| | Welcome to your new advertising account |
| | This will alert will appear when a new user signs up for Self Serve |
| | The alert should take the user to the Help Section/FAQ to learn more about |
| | how to use the product |
| | The alert will disappear once the user clicks on the alert to view the FAQ or |
| | selects remove |

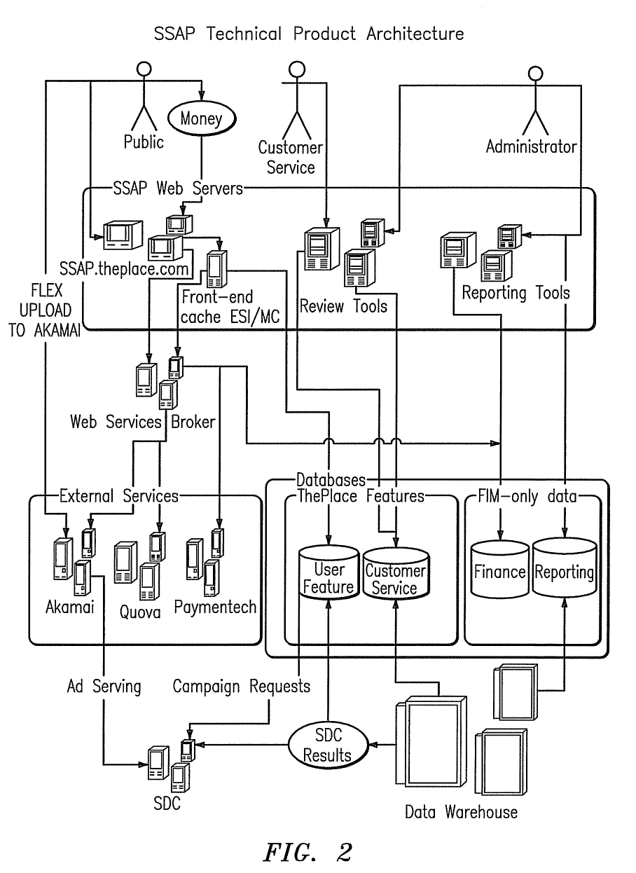

In exemplary embodiments, one or both of the self-serve platform and the ad serving platform are responsible for storing all campaign information, ads, targeting criteria and budget information. Reference is made to FIG. 2 for a more comprehensive exemplary self service platform architecture. Note is made of the “user feature” permitting creation of ads and campaigns, the review process associated with “Customer Service” and “Review Tools”, the ad serving and targeting components “SDC”, “Akamai”, “Quova” and “Web Services Broker”, and the finance and reporting components.

Various security features may be implemented with regard to the self service platform, including HTTPS protocol for login, signup, campaign management, etc. Without limiting the specification, the system may also incorporate session timeouts, password resets, etc.

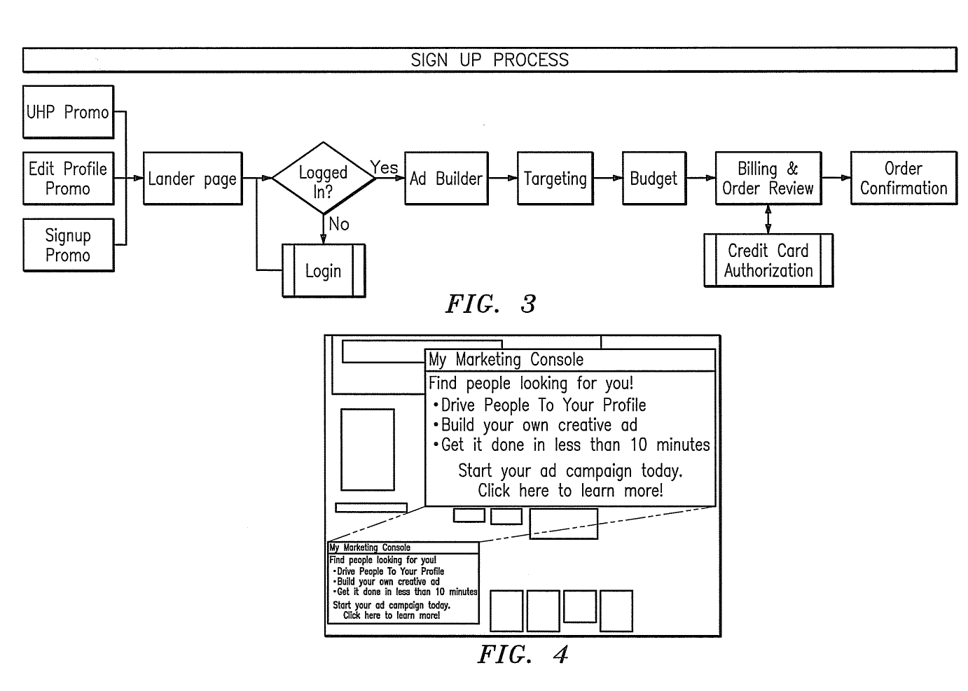

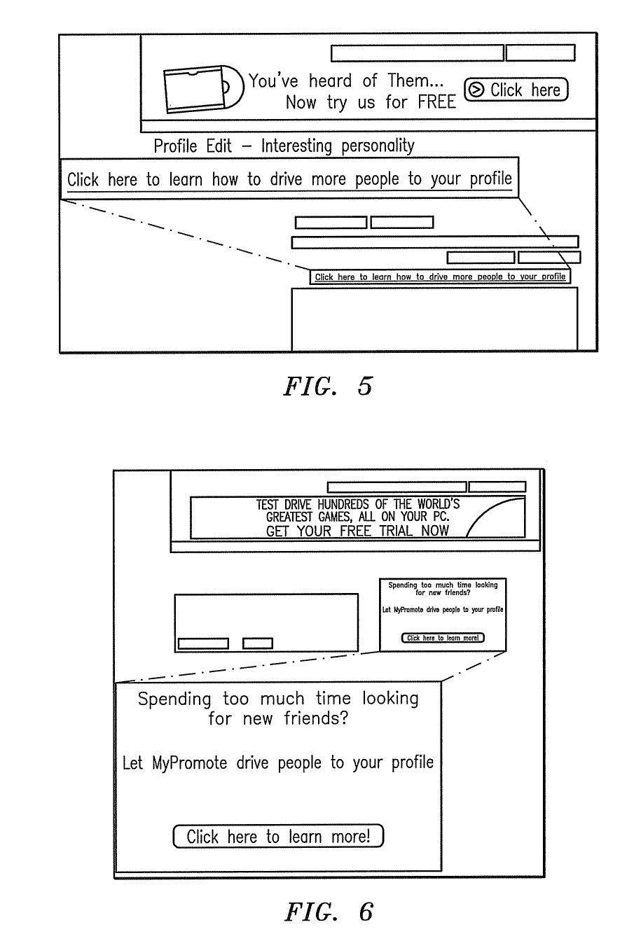

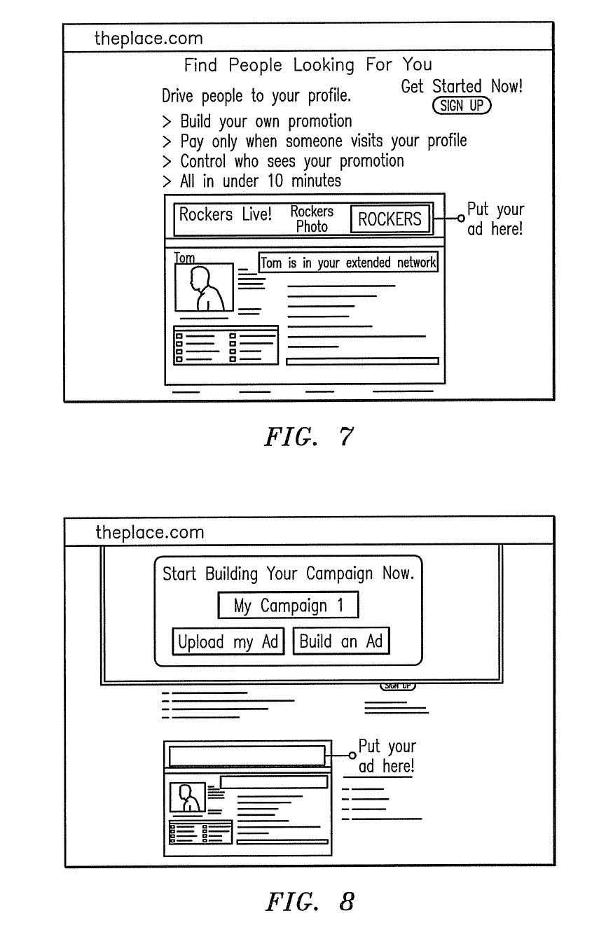

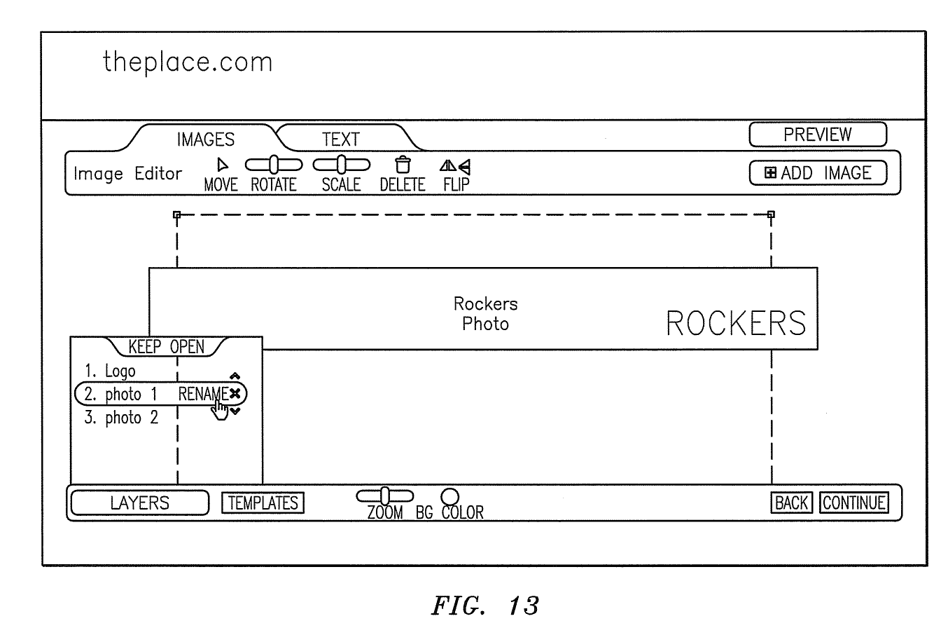

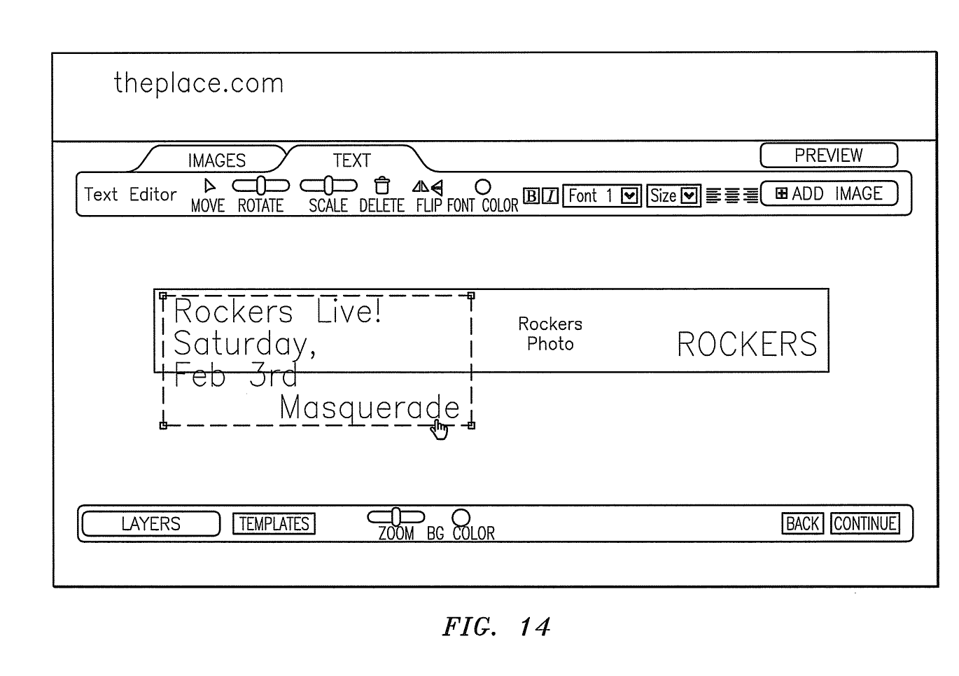

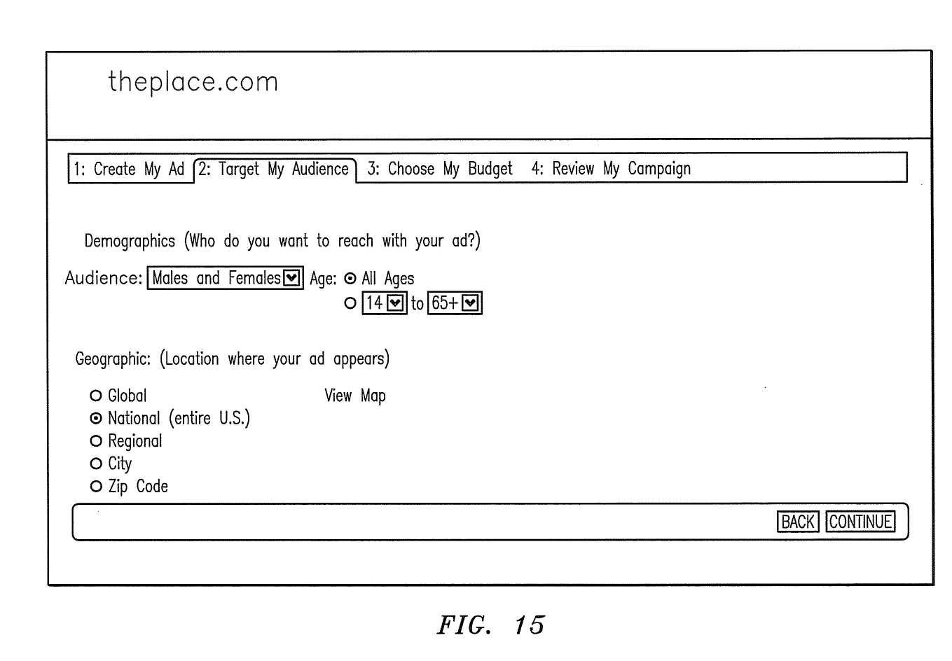

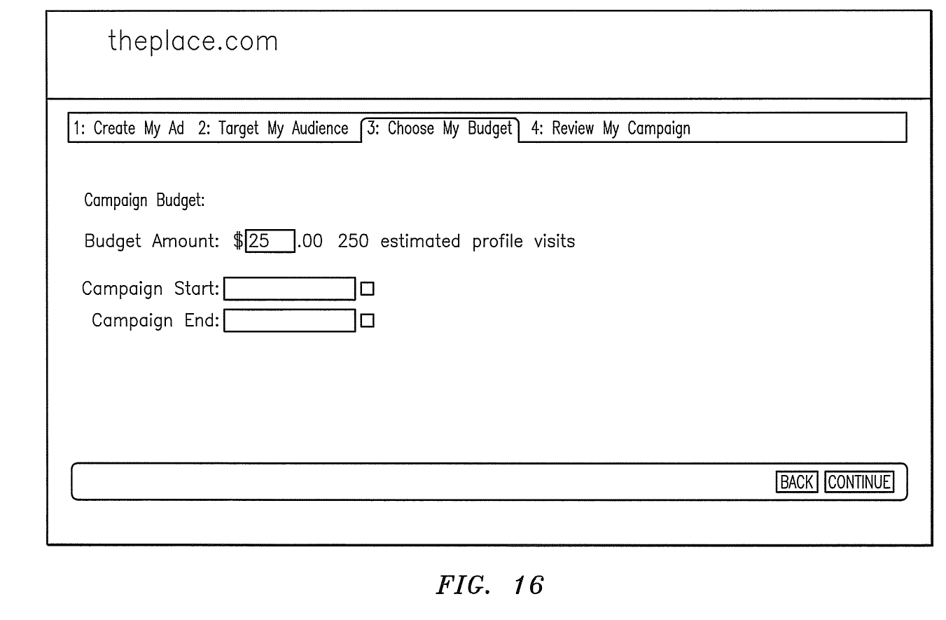

Reference is now made to FIG. 3, which illustrates an exemplary sign up process, including network promotional ads intended to drive network users interested in advertising to the self-serve platform (see also FIGS. 4-7), login, ad builder tools (see also FIGS. 8-14), targeting tools (see also FIG. 15), budget tools (see also FIG. 16), billing and order review (see also FIG. 17), and order confirmation (see also FIG. 18).

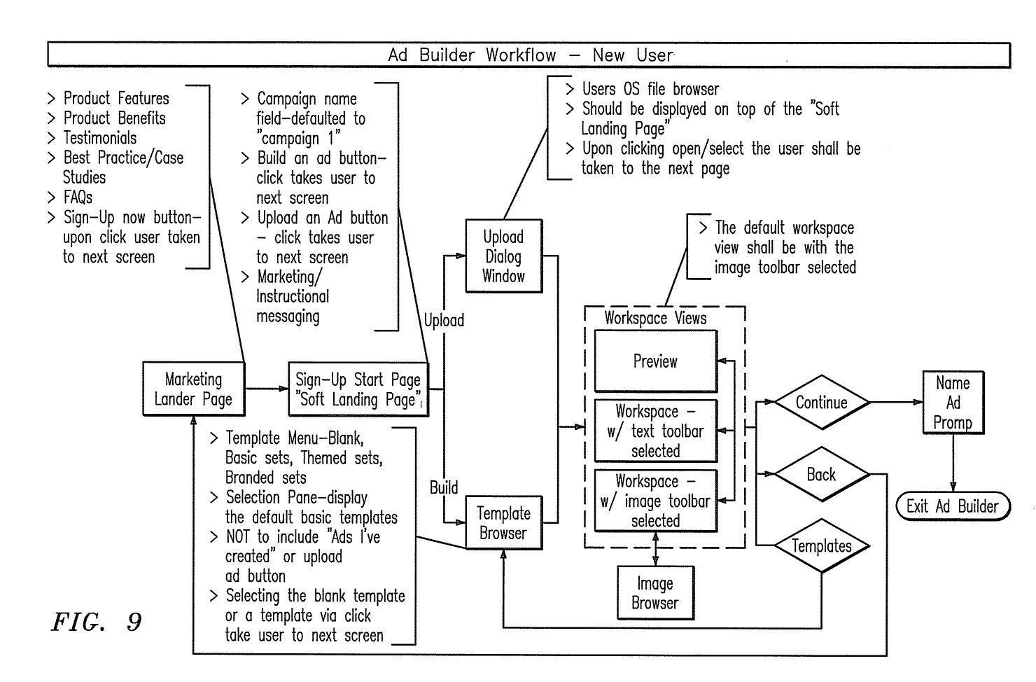

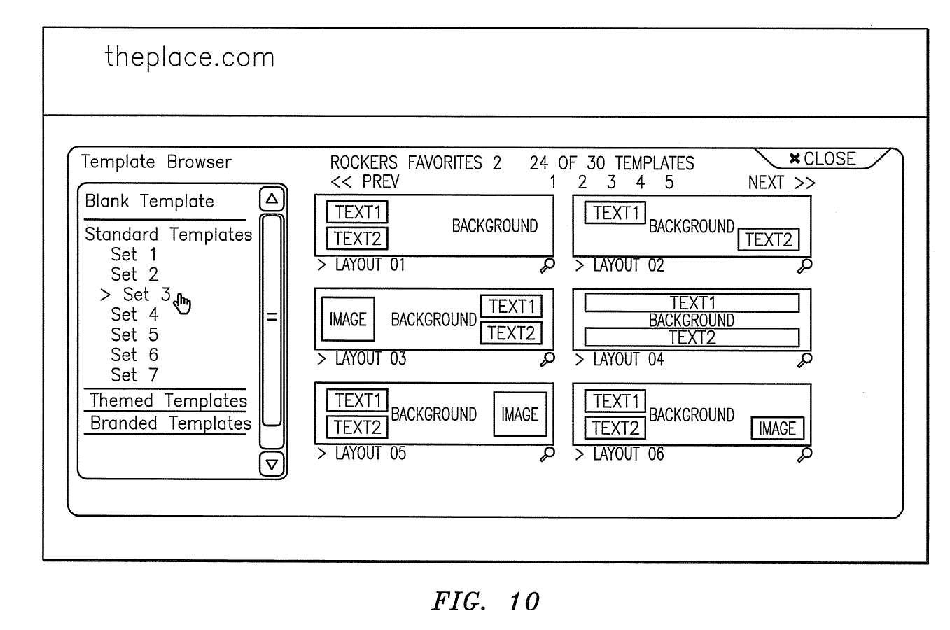

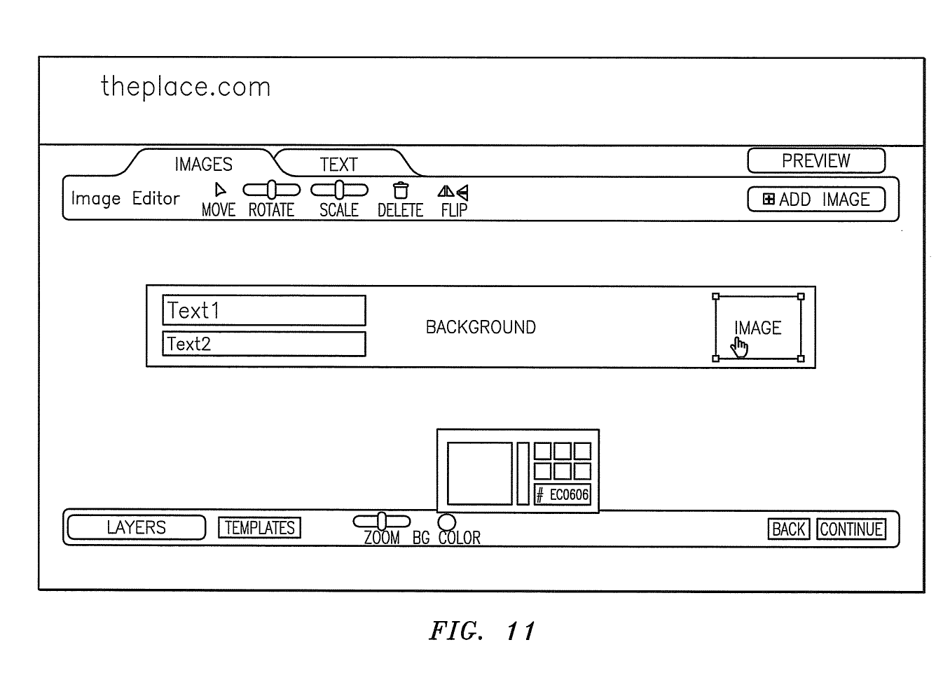

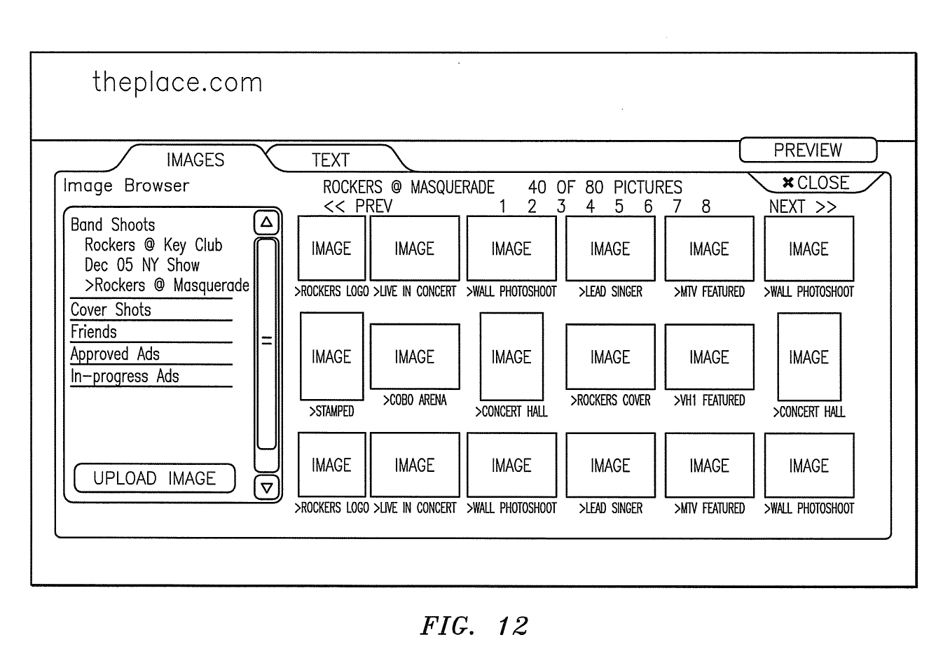

Referring again to FIG. 9, an exemplary ad builder workflow chart is illustrated. Such chart illustrates a marketing lander page, wherein various benefits, case studies, testimonials, etc. may be provided to a network user to entice the user to sign up. Upon signup (age, identity, etc. may be verified at this stage), the system provides tools for creation of leaderboard display ads, including ad templates, the ability to select and add media, change background colors, font styles and size, etc. Images and text may be edited, e.g., using nudge or move operations, rotate, scale, resize, delete, flip operations, etc.

Also, a blank template may be provided with a preset number of layers (e.g., limited to 30). The system may also make content (images, etc.) available from the user's network page/profile, and in another exemplary embodiment, maintains the same organizational structure as the network organizational structure. Media may also be uploaded from outside sources.

The system may allow users to enter customized marketing messages and allow editing of the same (font, color, position, style, etc.). A preview workspace may be provided to assist in the creation and modification of the advertisement, and versions of ads may be available in an ad library for viewing and/or modification (previously created ads may be imported as layered elements to enable such editing).

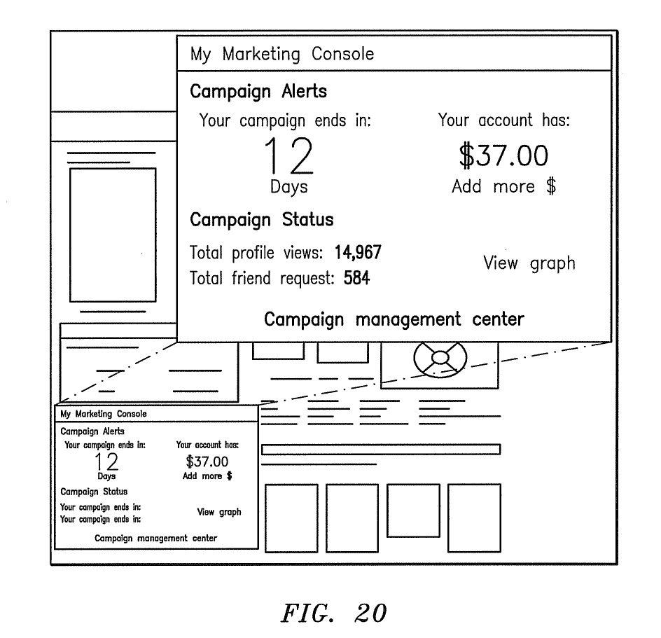

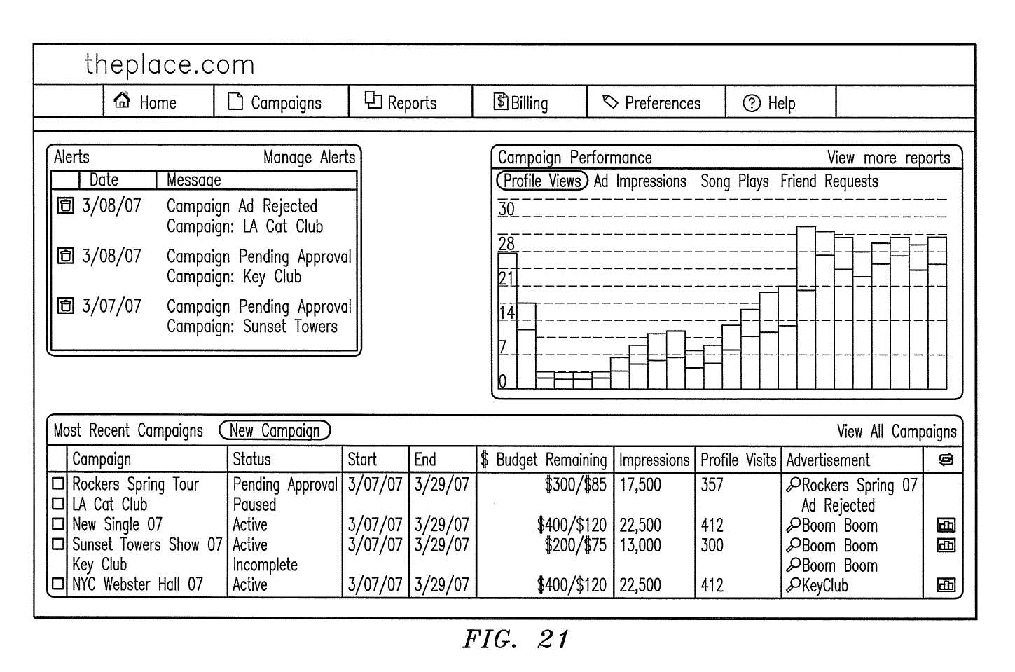

Reference is now made to FIG. 19, which illustrates an exemplary workflow (various management screens) for the management center. In the exemplary embodiment, a management dashboard provides access to Help/FAQ, Preferences, Billing, Reports, Campaign Summary, Campaign Details, and New Campaign. The management center may be accessed via direct access (the URL for the campaign manager and/or self serve platform) or optionally via a network user's profile page (see FIG. 20).

The exemplary dashboard provides users with a mechanism of easily navigating (as above) and easily monitoring the performance of the user's campaigns. Thus, the dashboard may provide a list of campaign names, status, start/end dates, starting/remaining budget, ad views, profile visits, ad previews (e.g., by mouse over popups) and report links. The dashboard can show a preset number of campaigns (e.g., 10), with a link to show all, or with a link for the next 10. The campaigns may be sorted or filtered various ways (e.g., most recent, by title, etc.). The dashboard may also provide various graphical report views, e.g., of ad views, profile visits, cost, etc.). An alerts link or display may also appear.

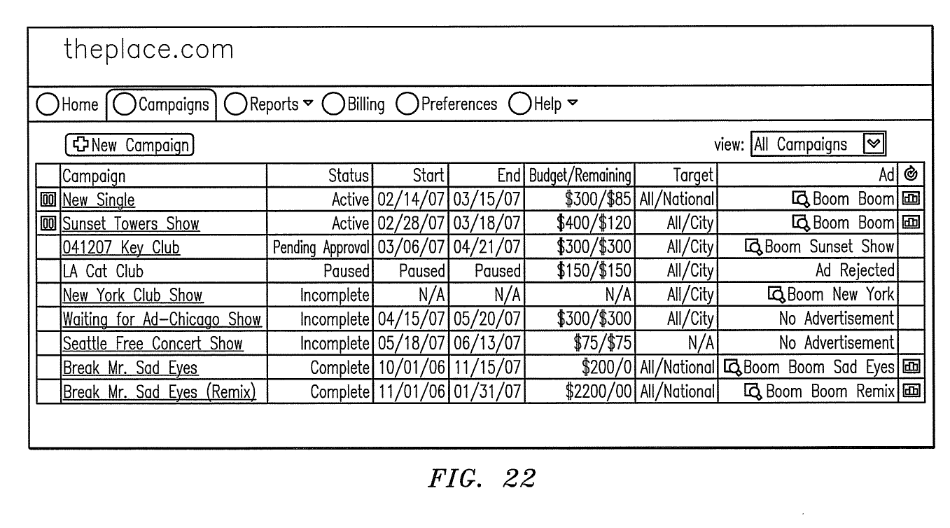

A campaign management table may also be provided (see the campaign summary of FIG. 22) that lists:
Campaign name
Status
Start/End date
Starting/remaining budget
Targeting summary
Ad name/preview
Pause button
Report link
   Thus, the user may easily view and/or pause campaigns from a simple, but informative table.

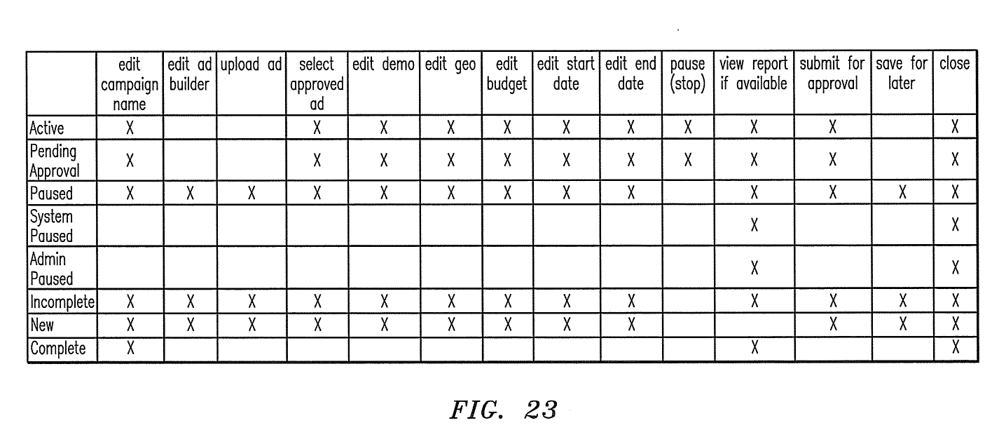

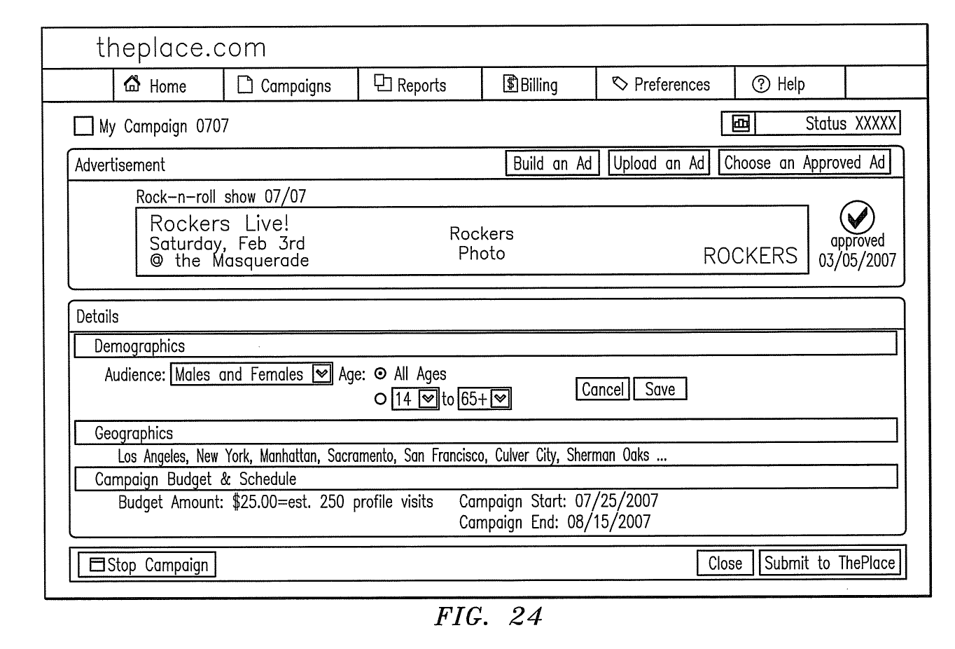

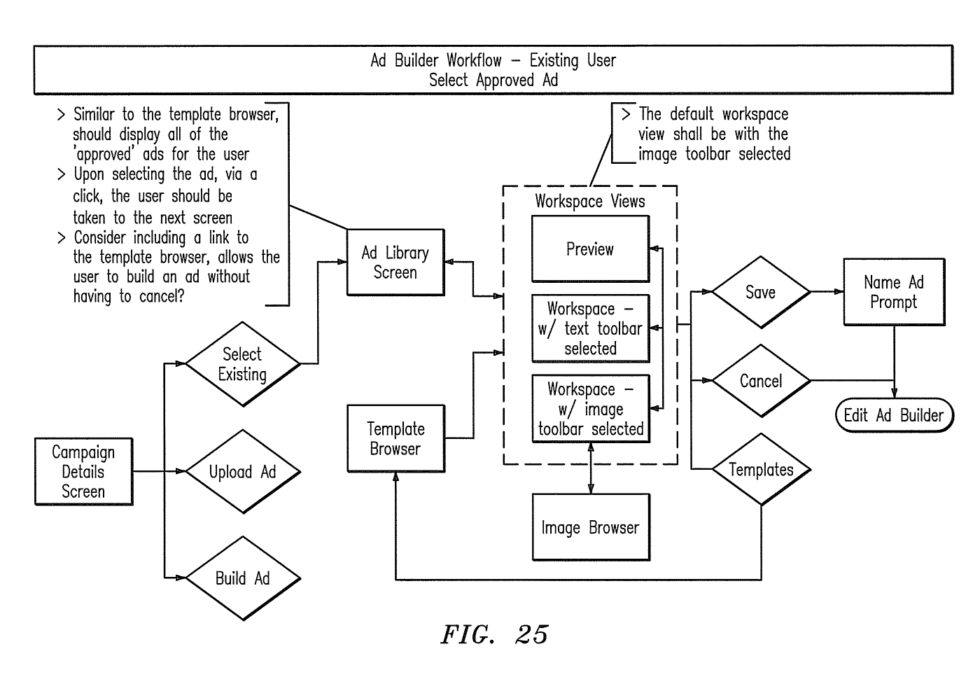

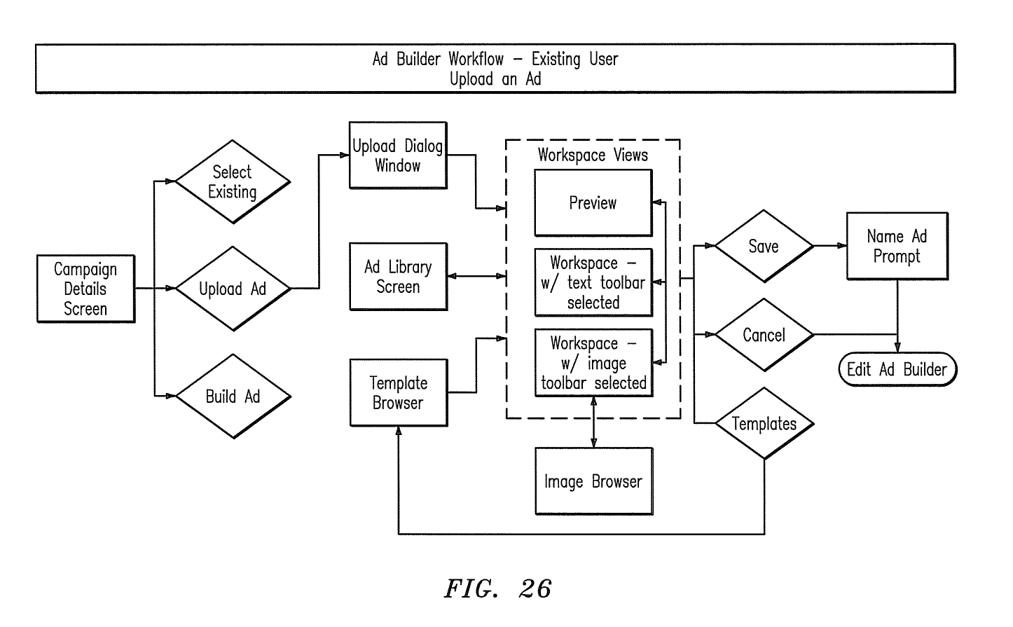

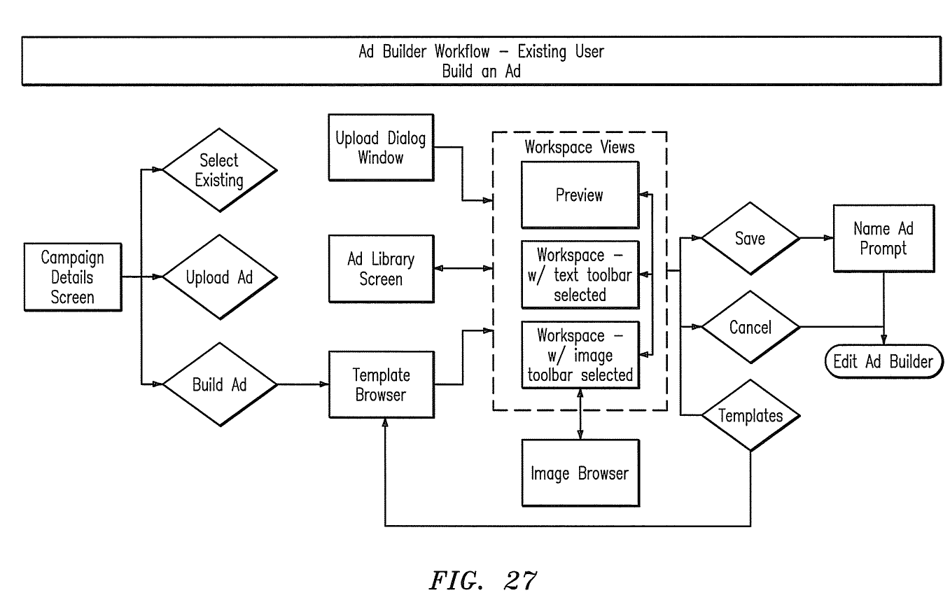

An exemplary campaign details page (see FIGS. 23 and 24) provide the following actions:
Create/edit campaign name
Create/edit a campaign's ad
Select/Edit targeting criteria (demo and geo)
Select/Edit campaign budget
Select/Edit campaign start/end dates
Pause/Restart a campaign
Submit new/modified campaigns for approval
   FIG. 23 illustrates an exemplary display showing various actions that may be available given a particular campaign state. Ads of a campaign may be created or edited by modifying a current ad (not available for new campaigns), selecting a previously approved ad (see FIG. 25), building a new ad (see FIG. 27) or uploading an ad (see FIG. 26). Targeting, budgeting and timing options may also be edited (see FIG. 24).

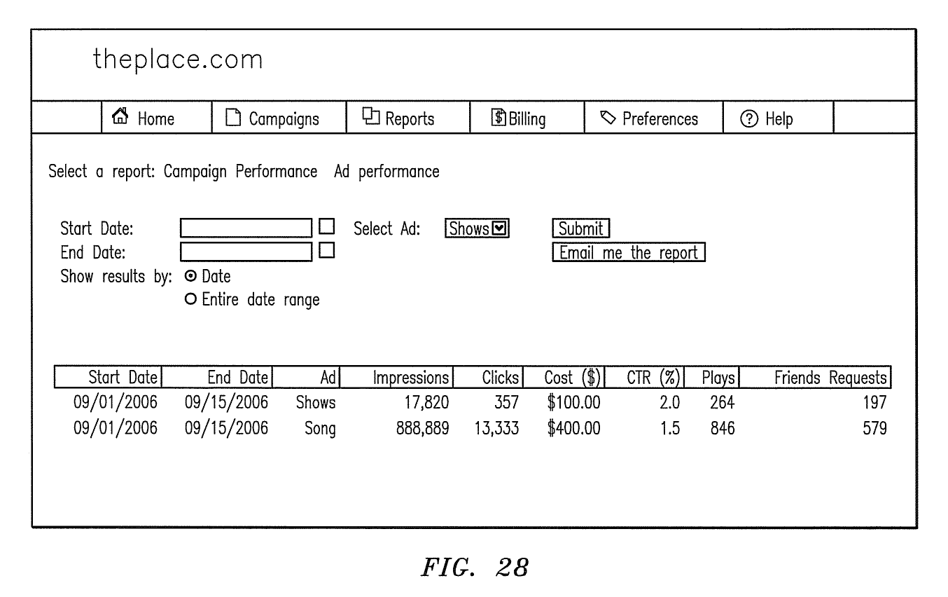

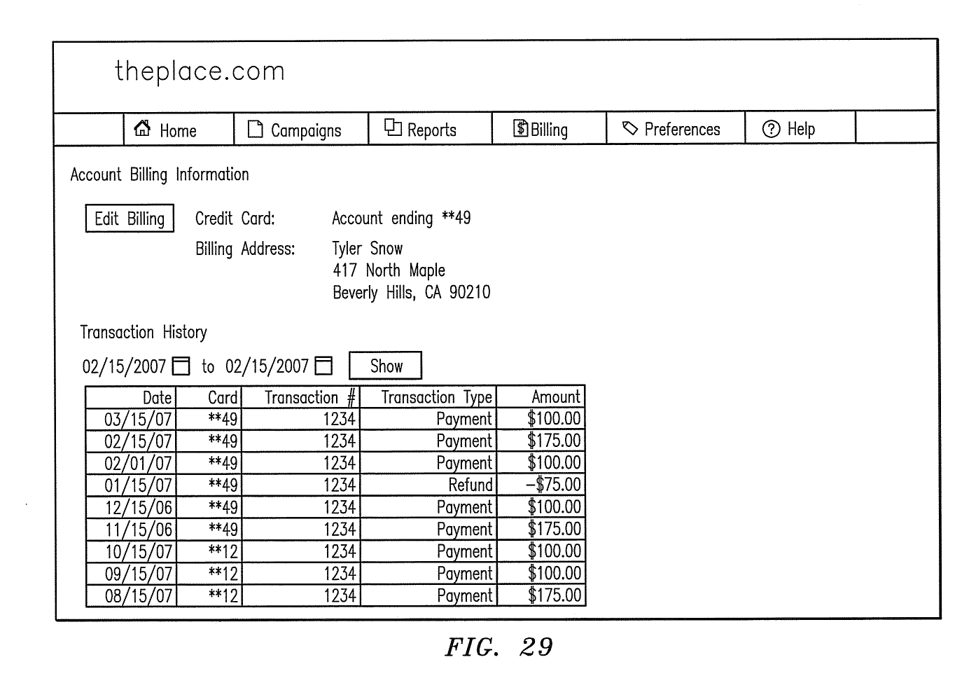

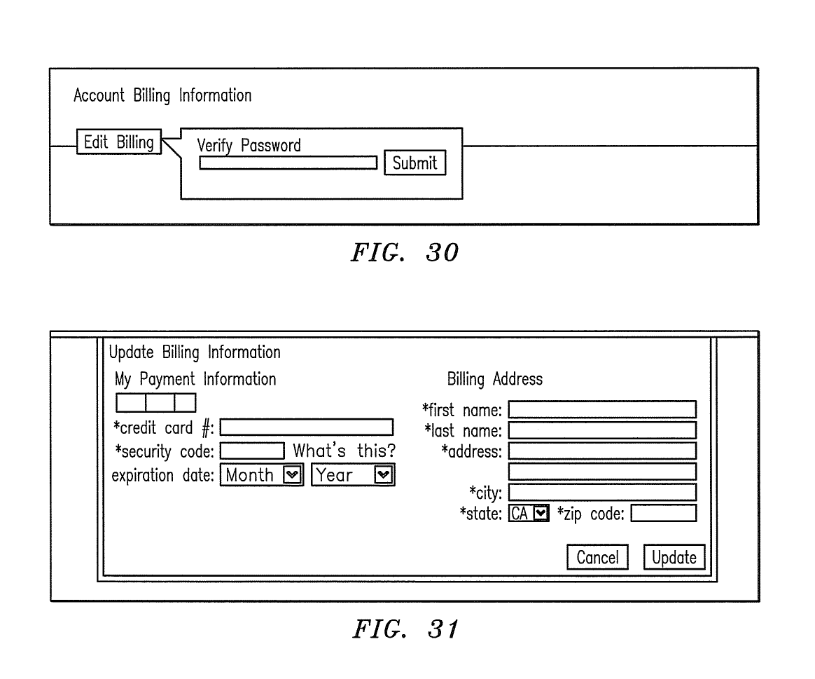

Referring now to FIG. 28, an exemplary report interface permits the generation of one or more performance reports. In exemplary embodiments, users may define the date range for a report. Such reports may be rolled up across the date range or broken out by day. They may be viewed within the portal, downloaded (e.g., .csv, .tsv, .xls) or emailed.

With reference to FIGS. 29-31, an exemplary billing interface permits editing of billing information, allows filtered or sortable viewing of billing history (e.g., by transaction type), and permits portal viewing, download, etc. of the reports.

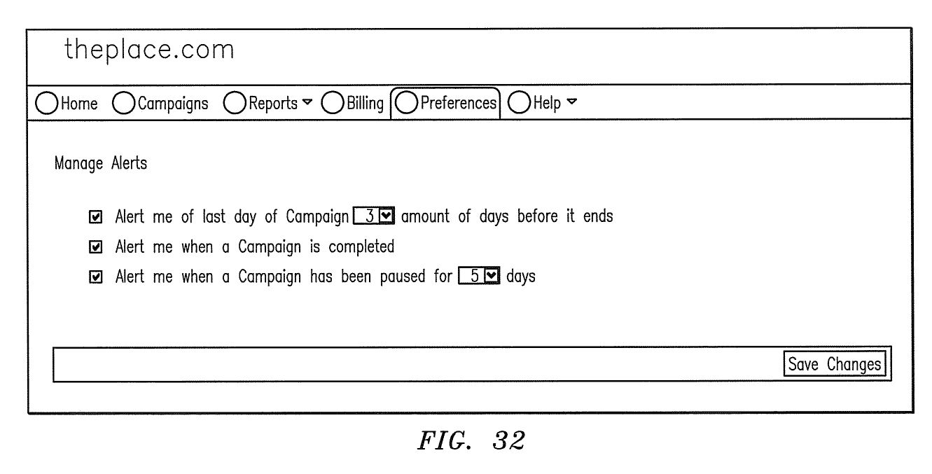

With reference to FIG. 32, an exemplary preferences interface allows users to manage and configure their alerts, including configuring alerts a set number of days before a campaign ends and alerts for a set number of days a campaign has been paused. Other settings may also be accessed, e.g., security options, passwords, user names, etc.

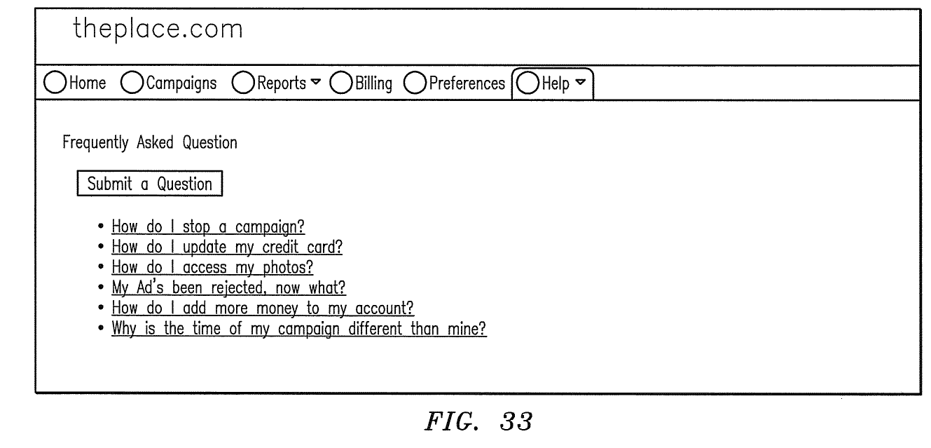

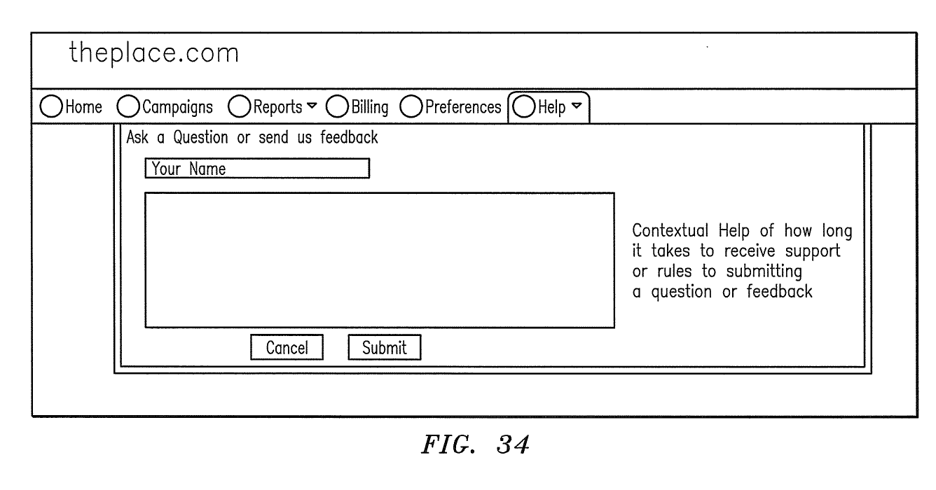

FIGS. 33-34 illustrate an exemplary Help/FAQ interface, providing access to FAQ documents, tutorials, best practice documents, etc. The interface also provides a contact interface for user questions, feedback, etc.

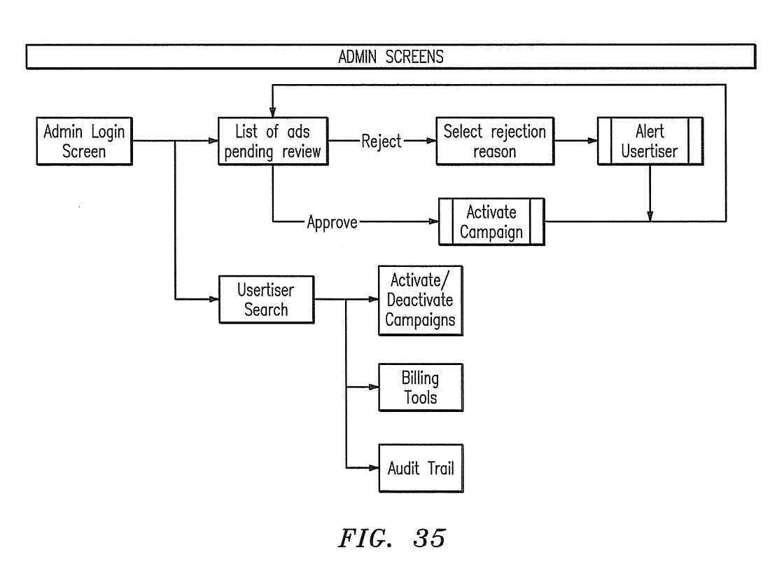

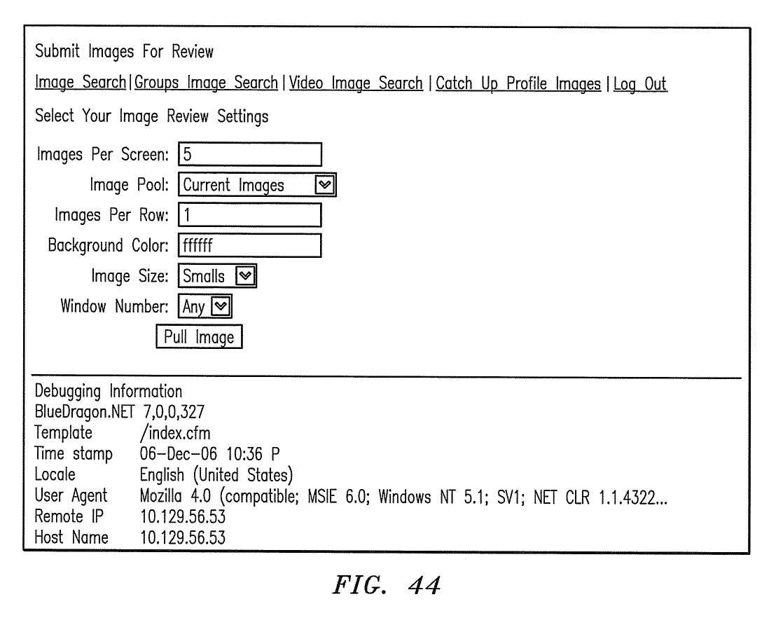

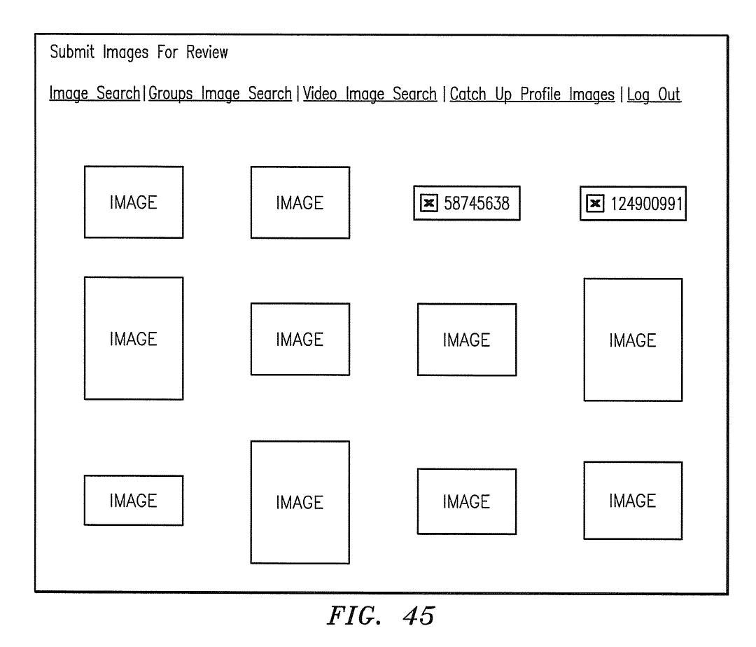

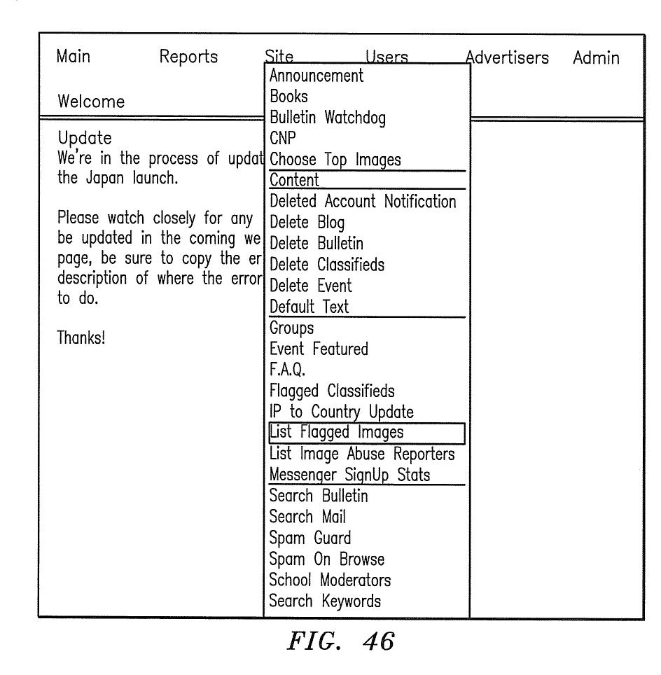

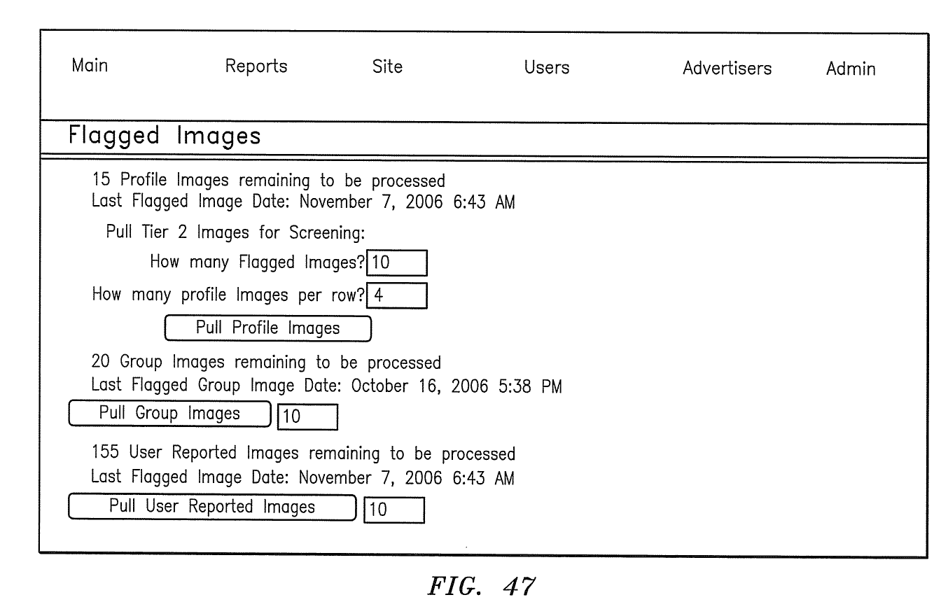

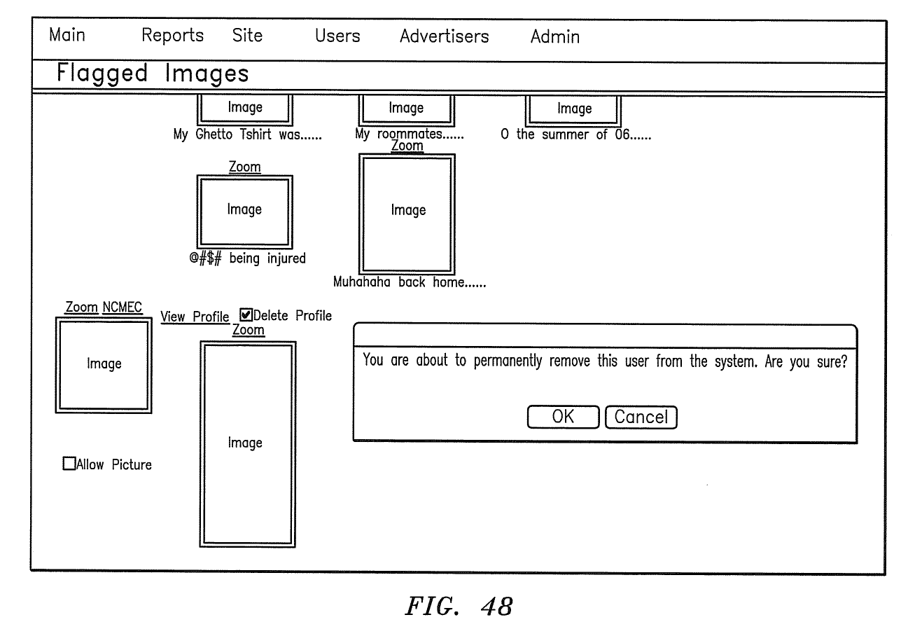

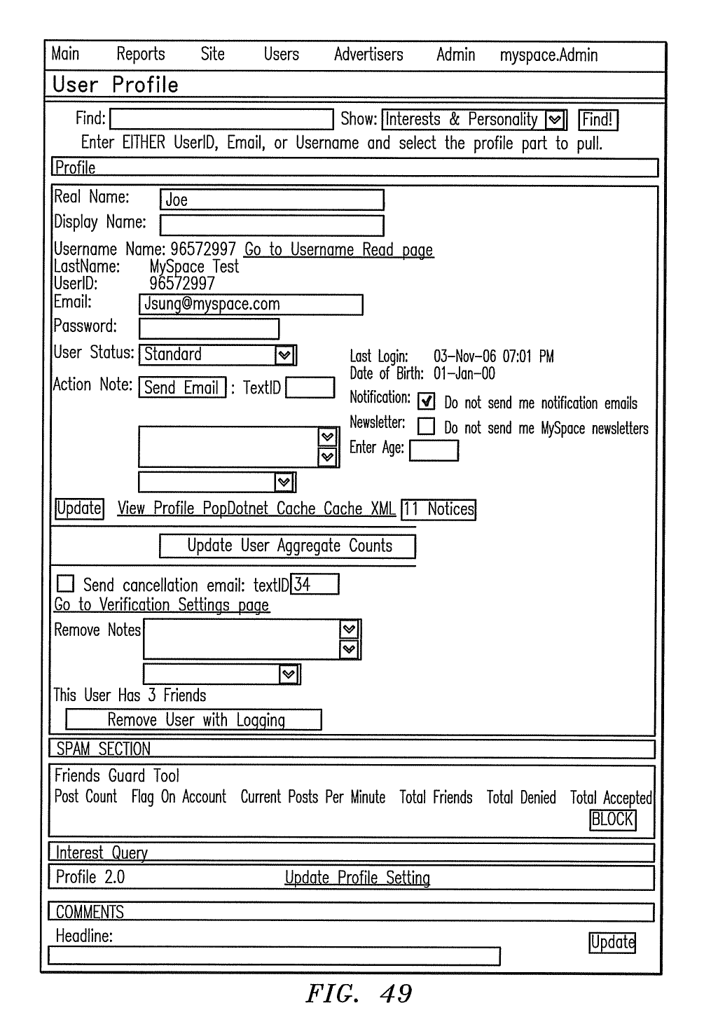

Referring now to FIG. 35, an exemplary admin portal interface may be provided. In exemplary embodiments, the admin portal is provided only from a secure admin location and not accessible on the Internet at large. Once logged in, ad admin may view, approve and reject ads pending review or may search through users, activate or deactivate user campaigns, utilize billing tools and conduct audit trails. As illustrated by FIGS. 44-48, the admin portal may also permit more general profile and media review functions (flagging of potentially objectionable images, etc.)

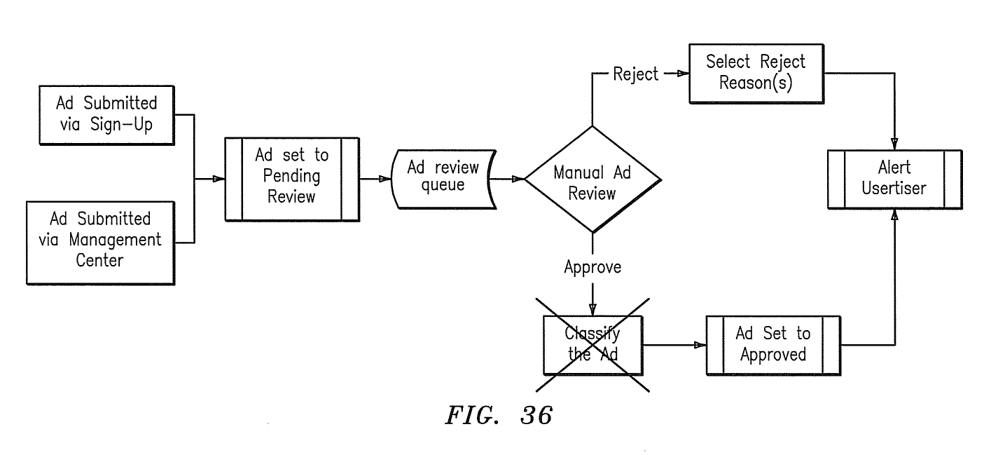

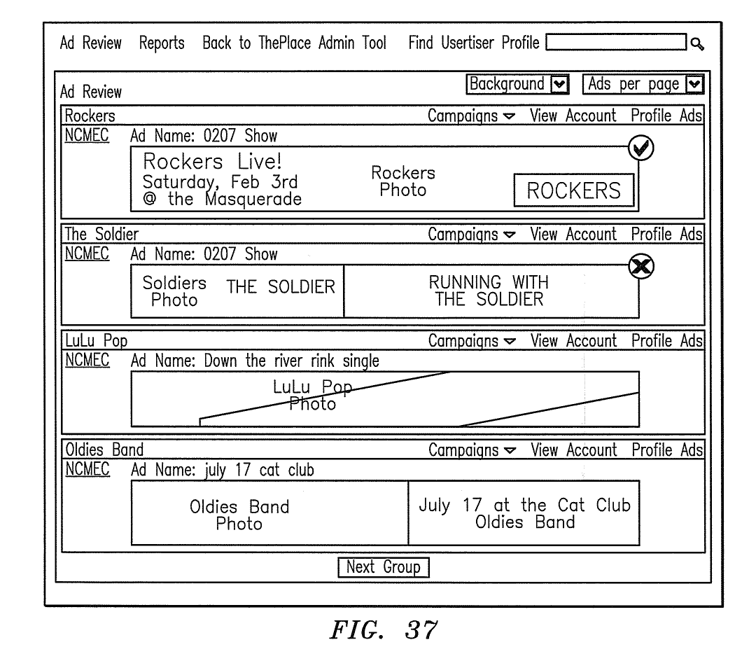

An exemplary ad review process is illustrated in FIG. 36, including various methods for submission for review, reclassification of the ad as pending, queuing of the review, manual approval or rejection and subsequent disposition for the ad. An interface for the reviewer (see e.g., FIG. 37) may allow the reviewer display options, e.g., number of ads per page, all ads associated with a profile, display of the ad name, lists of sister campaigns associated with the user, change of background color of the review pain, review of campaign details associated with the ad, etc.

In an exemplary embodiment, a streamlined process for manual review may be implement, e.g., where clicking once on an ad sets the ad's status to approved, clicking twice sets the status to rejected (options for display of reasons may be provided), clicking a third time sets the status to pending, and clicking a fourth time repeats the cycle. One or more possible reasons may be provided for quick selection by the reviewer, e.g., inappropriate ad images, inappropriate ad text, inappropriate profile content, or other (with open text field).

The system may also quickly link the reviewer to the user's profile so that the reviewer can ensure that the profile matches the ad and that the profile's content is acceptable (with exemplary option to delete the user's profile if warranted). The system may also be configured to allow reviewer's to quickly report user's to the proper authorities if potentially criminal material is within the ad or the profile.

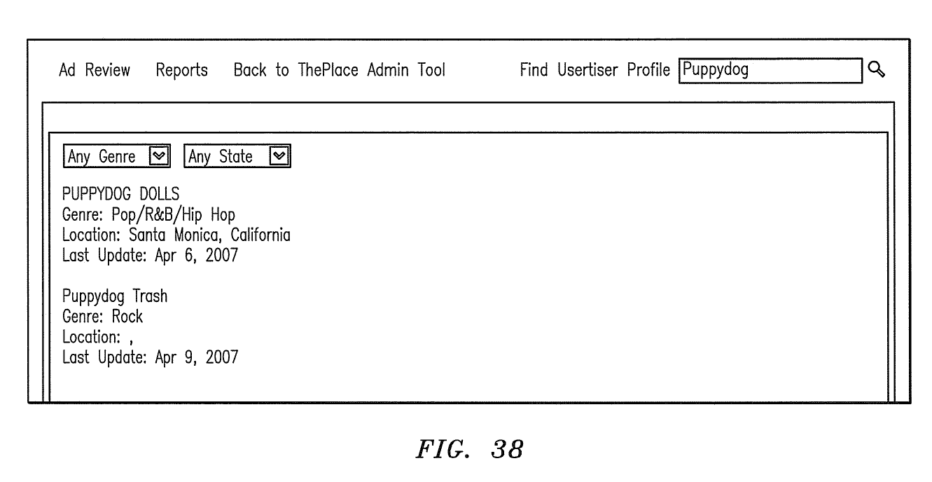

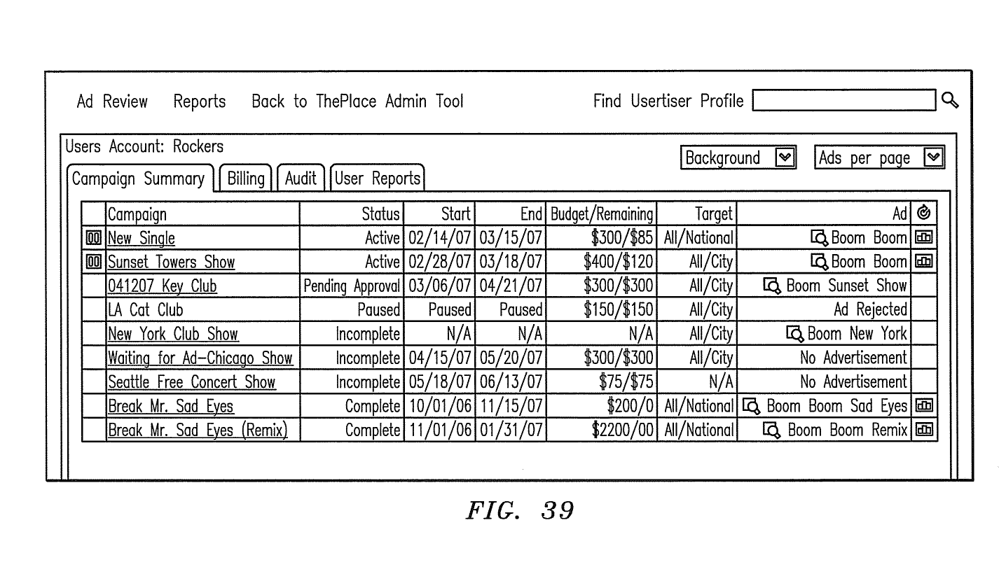

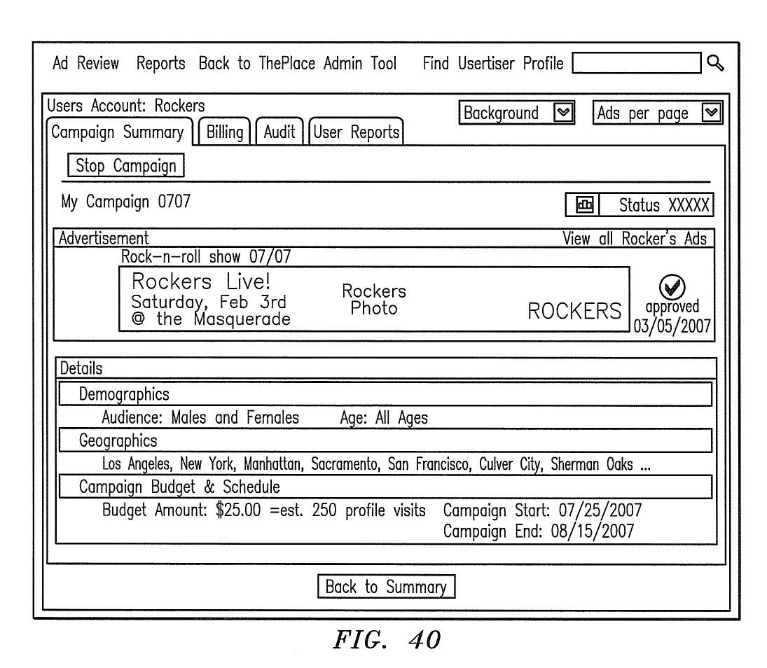

Referring to FIG. 38, an exemplary admin portal search interface also may permit the admin the ability to search for users by profile URL, by keyword, by profile name, by email address, by friend ID, etc. If multiple results are returned, the list may be presented as filtered by various relevance factors. Clicking on the user's profile name may take the admin to the campaign summary view of the user (See FIG. 39). Clicking on any one campaign therein, the admin may view (and modify the status of (e.g., from active to stopped)) the user campaign details view (see FIG. 40). When stopping the campaign, the system may give the admin a selectable list of reasons for the change (inappropriate ad images, etc.). The system may also provide links to the admin profile review page, the billing screen, the audit trail and the advertiser's view of their performance reports. The system may also provide indication to an admin when the user ad is targeted at underage network users.

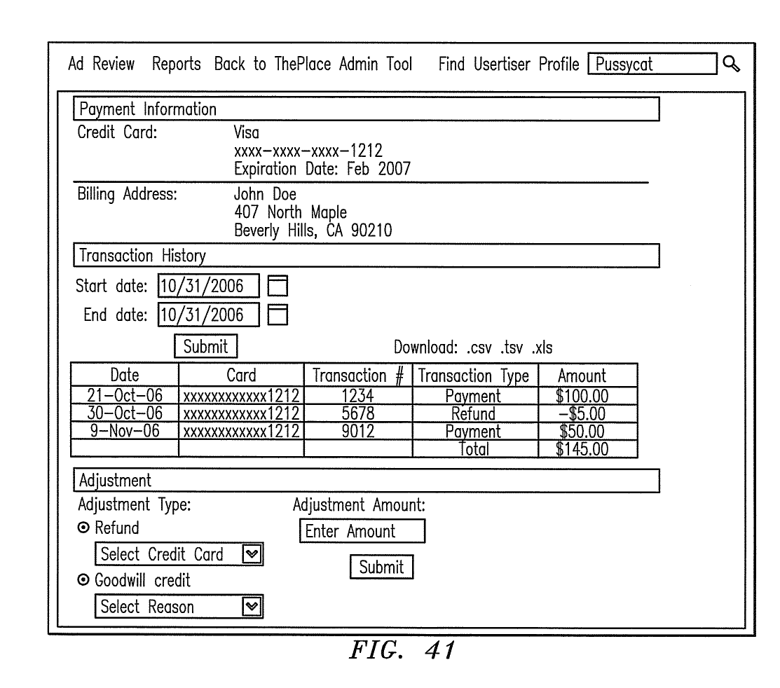

An exemplary admin billing screen is illustrated at FIG. 41, which screen provides an admin the ability to view the user's active credit card information, billing address information, billing history (e.g., by date range) as well as the ability to refund payments and provide credits or adjustments. The admin may download billing history in a variety of formats.

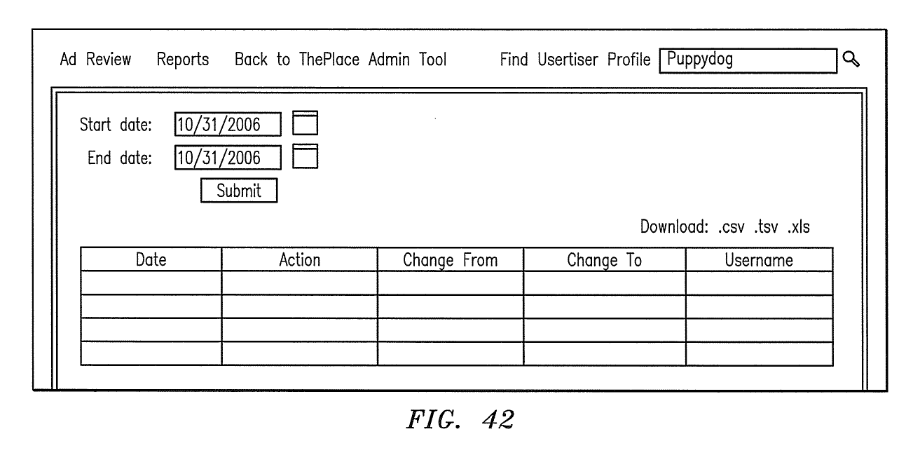

An exemplary audit trails screen is illustrated at FIG. 42, wherein the audit trail screen provides an admin the ability to select date ranges for reports, download reports, etc. of the audit trail.

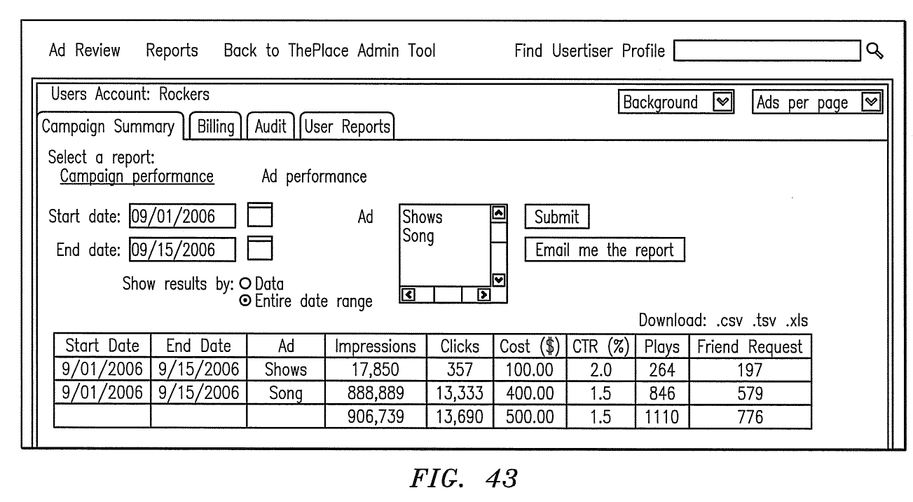

An exemplary admin reports screen is illustrated at FIG. 43, which provides the admin the ability to generate reports as the advertiser would see them within the user's campaign management center.

It will be apparent to those skilled in the art that, while exemplary embodiments have been shown and described, various modifications and variations can be made to the self serve advertising system and method disclosed herein without departing from the spirit or scope of the invention. Accordingly, it is to be understood that the various embodiments have been described by way of illustration and not limitation.

What is claimed is:

1. A self serve advertising platform, comprising:
an advertising server configured to provide advertisements into active internet web pages for viewing by a user accessing said web page; and
a self serve advertising server interface that provides user sign up, account creation, tools and interfaces for creation, customization or upload of advertisements, tools for creation of campaigns, including defining campaign objectives and parameters, and setting of budgetary or time constraint limits on the advertising.

2. A platform in accordance with claim 1, wherein said platform further comprises a signup process subsystem, a management center subsystem, and an administrative center subsystem.

3. A platform in accordance with claim 1, wherein said self serve advertising server interface is configured to permit a user to define a desired target viewer as part of a desired campaign objective or parameter.

4. A platform in accordance with claim 3, wherein said self serve advertising server interface permits a user to target viewers based on demographics, geographies, gender or age.

5. A platform in accordance with claim 1, wherein said self serve advertising server is configured to collect billing information based on defined billing cycles.

6. A platform in accordance with claim 1, wherein said self serve advertising server interface is configured to provide internal and external reports on billing and campaign progress.

7. A platform in accordance with claim 1, wherein said advertising server includes an ad data warehouse, an internal order management system, and a campaign database.

8. A platform in accordance with claim 7, wherein said advertising server further includes ad server optimization components.

9. A platform in accordance with claim 2, wherein said signup process subsystem is configured to access a user's network profile information and content.

10. A platform in accordance with claim 2, wherein said management center subsystem or administrative center subsystem automatically triggers an alert for one or more of the last day of a campaign, the completion of a campaign, pausing of a campaign, an administrative campaign stop, credit card payment made, credit card payment declined, credit card about to expire, credit card expired, approval of a campaign's ad, rejection of a campaign's ad, pending approval of a campaign's ad is pending approval, and a new user signup.

11. A platform in accordance with claim 1, wherein said self serve advertising server interface is configured to provide tools for creation of leaderboard display ads, including ad templates, the ability to select and add or edit media.

12. A platform in accordance with claim 1, wherein said self serve advertising server interface is configured to add media from a user's network profile or content.

13. A platform in accordance with claim 2, wherein said management center subsystem is configured with the user interface to provide to the user one or more of a list of campaign names, status, start and end dates, starting budget and remaining budget, ad views, profile visits, ad previews and report links.

14. A platform in accordance with claim 13, wherein said management center subsystem is configured with the user interface to provide to the user graphical report views of one or more of campaign names, status, start and end dates, starting budget and remaining budget, ad views, profile visits, ad previews and report links.

15. A platform in accordance with claim 2, wherein said administrative center subsystem is configured to provide an administrative portal interface that is configured such that an admin may view, approve and reject advertisements pending review.

16. A platform in accordance with claim 2, wherein said administrative center subsystem is configured to provide an administrative portal interface that is configured such that an admin may search through users, activate or deactivate user campaigns, utilize billing tools or conduct audit trails.
